(19) United States
(12) Patent Application Publication
(10) Pub. No.: US 2021/0306357 A1
(43) Pub. Date: Sep. 30, 2021

(54) SORTING DEVICE, COMMUNICATION SYSTEM, AND SORTING METHOD

(71) Applicant: Nippon Telegraph and Telephone Corporation, Tokyo (JP)

(72) Inventors: Hiroyuki Onishi, Tokyo (JP); Takeaki Nishioka, Tokyo (JP); Yuhei Hayashi, Tokyo (JP)

(21) Appl. No.: 17/260,280

(22) PCT Filed: Jul. 17, 2019
(86) PCT No.: PCT/JP2019/028103

§ 371 Date: Jan. 14, 2021

(30) Foreign Application Priority Data
Jul. 24, 2018 (JP) 2018-138773

(51) Int. Cl. H04L 29/06; H04L 12/823; H04L 29/12

(52) U.S. Cl. CPC H04L 63/1416; H04L 47/32; H04L 63/0236; H04L 69/22; H04L 63/0263; H04L 61/2007

(57) ABSTRACT

A copy unit (11c) copies packets received from a network. A compression unit (11d) compresses the payload of each of the copied packets and transfers each of the compressed packets to a security apparatus (20a). A storage unit stores filter information identifying the attack packet detected by the security apparatus, and a discarding unit (11a) uses the filter information to discard the attack packet. The storage unit stores an assignment rule designating a processing method for each predetermined flow of the network traffic, and an assignment unit (11b) uses the assignment rule to assign each of the packets received from the network to a copy unit (11c) or to another security apparatus (20b), for each of the predetermined flows.

### TECHNICAL FIELD

The present invention relates to an assignment apparatus, a communication system, and an assignment method.

### BACKGROUND ART

One known technique as a countermeasure for Distributed Denial of Service (DDoS) attack relies on the following mechanism, Specifically, traffic to the targets of the DDoS attack is entirely guided to a DDoS mitigation apparatus (security apparatus), and the security apparatus discards attack packets and allows non-attack packets to pass through (see Non Patent Literature 1).

The security apparatus executes various types of analysis processing in multiple stages, and discards the packet at any of the stages where abnormality is detected. Not all the types of analysis processing executed by the security apparatus require a payload of a packet. In other words, there is analysis processing that can be executed only using lower layer information included in 5-tuple of the header and the like. Examples of this include processing known as InvaidPackets in which an invalid port number is determined, processing known as IP Address Filter Lists in which a packet of a designated IP address is discarded, and the like.

### CITATION LIST

### Non Patent Literature

Non Patent Literature 1: Arbor Networks, “Arbor Networks TMS”, [online]; Arbor Networks, [ Search Jun. 29, 2018]; Internet: URL:http://jp.arbornetworks.com/wp-content/uploads/2016/06/ds_tms_jp2016-030516AP-number-updated.pdf

### SUMMARY OF THE INVENTION

### Technical Problem

Unfortunately, the known technique involves a risk of the security apparatus running short of resources due to payloads not used for analysis processing transferred thereto. Specifically, the payloads are not used when the packets are discarded through the analysis processing using the information about the lower layer in the earlier stage at the security apparatus. The security apparatus may run short of resources due to such payloads not to be used.

The present invention is made in view of the above, and an object of the present invention is to reduce the amount of data transferred to a security apparatus.

### Means for Solving the Problem

An assignment apparatus according to the present invention for solving the problem described above and achieving an object is configured to transfer packets received from a network to a user and to a security apparatus configured to detect an attack packet and includes a copy unit configured to copy each of the packets received from the network and a compression unit configured to compress a payload of each of the packets copied to transfer a packet with the compressed payload to the security apparatus,

### Effects of the Invention

With the invention, the amount of data transferred to a security apparatus can be reduced.

### BRIEF DESCRIPTION OF DRAWINGS

FIG. 1 is a schematic diagram illustrating a schematic configuration of a communication system including an assignment apparatus according to the present embodiment.

FIG. 2 is an explanatory diagram illustrating an overview of processing executed by a security apparatus.

FIG. 3 is an explanatory diagram illustrating an overview of processing executed by the assignment apparatus.

FIG. 4 is a schematic diagram illustrating an example of a schematic configuration of the assignment apparatus according to the present embodiment.

FIG. 5 is an explanatory diagram illustrating processing executed by the assignment apparatus.

FIG. 6 is an explanatory diagram illustrating processing executed by the assignment apparatus.

FIG. 7 is an explanatory diagram illustrating processing executed by the assignment apparatus.

FIG. 8 is an explanatory diagram illustrating processing executed by the assignment apparatus.

FIG. 9 is a sequence diagram illustrating an example of an assignment processing procedure.

FIG. 10 is a diagram illustrating one example of a computer executing an assignment program.

### DESCRIPTION OF EMBODIMENTS

Hereinafter, embodiments of the present disclosure will be described in detail with reference to the drawings. Note that the present invention is not limited by the embodiment. In illustration of the drawings, the identical parts are denoted by the same reference signs.

### Configuration of Communication System

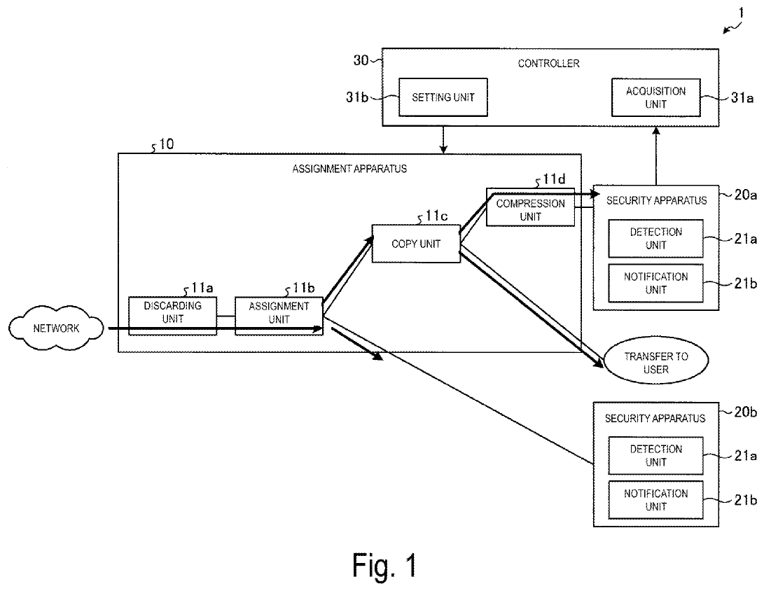

FIG. 1 is a schematic diagram illustrating a schematic configuration of a communication system including an assignment apparatus according to the present embodiment. As illustrated in FIG. 1, the communication system 1 according to the present embodiment includes an assignment apparatus 10, two types of security apparatuses including a security apparatus 20a and a security apparatus 20b, and a controller 30. Note that in the following description, a set of packets with common 5-tuple will be referred to as a flow.

The security apparatus 20a is a DDoS mitigation apparatus that executes simple analysis processing on a packet only using lower layer information included in 5-tuple of the header of the packet and the like. On the other hand, the security apparatus 20b is a DDoS mitigation apparatus that executes normal analysis processing on a packet using higher layer information such as contents of the payload of the packet. The security apparatus 20a and the security apparatus 20b may each include a plurality of apparatuses. The security apparatus 20a and the security apparatus 20b may also be a virtual security apparatus built on the virtualization infrastructure server.

The assignment apparatus 10 executes assignment processing described later to assign and transfer the packets received from the network to a user and to the security apparatus (20a, 20b). Specifically, the assignment apparatus 10 compresses the payload of a packet assigned to the security apparatus 20a that executes the simple analysis processing, and transfers a packet with the compressed payload thereto. The assignment apparatus 10 further assigns and transfers the packet, to be transferred to the security apparatus, to two types of the security apparatus 20a or the security apparatus 20b.

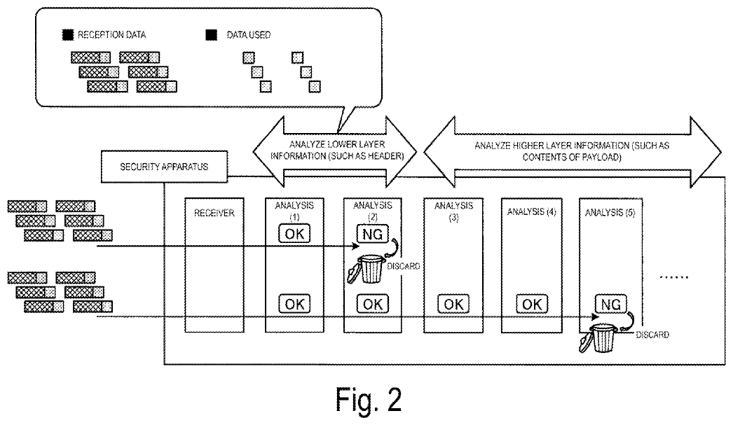

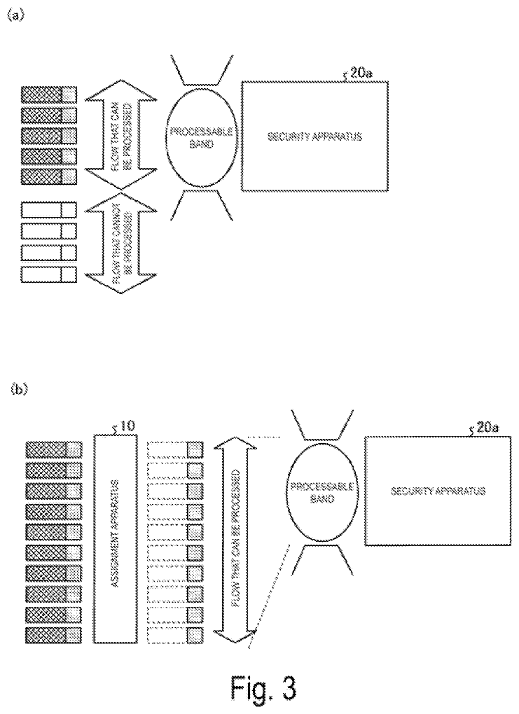

FIG. 2 is an explanatory diagram illustrating an overview of processing executed by the security apparatus. FIG. 3 is an explanatory diagram illustrating processing executed by the assignment apparatus 10. As illustrated in FIG. 2, only the header in the packets received from a network is used in simple analysis (analysis (1), (2) in FIG. 2) only using the lower layer information such as a header, which is one of types of analysis processing executed in a plurality of stages for attack packet detection at the security apparatus.

When the result of the simple analysis is OK (analysis (1)), the next processing (analysis (2)) is subsequently executed. When the result of the simple analysis is NG (abnormal) (analysis (2)), the packet is discarded with the payload unused.

A processable band (resource) of the security apparatus is limited. Thus, reception of a packet including a payload that would not be used may result in a failure to process a flow as illustrated in FIG. 3(a).

With the assignment apparatus 10 according to the present embodiment, as illustrated in FIG. 3(b), the payload of each of the packets received by the security apparatus 20a is compressed. Thus, more flows can be processed by the security apparatus 20a without changing the processable band.

Description is given with reference to FIG. 1 again. The controller 30 controls the assignment apparatus 10. For example, the controller 30 receives a result of detecting the attack packet by the security apparatus 20a and the security apparatus 20b, and sets filter information identifying the attack packet, for the assignment apparatus 10, Furthermore, the controller 30 sets, for the assignment apparatus 10, a packet assignment rule for each flow to the security apparatus 20a, the security apparatus 20b, or the user.

### Configuration of Security Apparatus

The security apparatus (20a, 20b) is implemented by a Central Processing Unit (CPU). a Network Processor (NP), a Field Programmable Gate Array (FPGA), or the like, and includes a detection unit 21a and a notification unit 21b. The detection unit 21a detects an attack packet by analyzing each of the packets received from the assignment apparatus 10. Specifically, the detection unit 21a executes the simple analysis processing or the normal analysis processing to detect the attack packet. In addition, the notification unit 21b notifies the controller 30 of information about the attack packet detected.

The security apparatus 20a executes the simple analysis processing on a packet by only using lower layer information included in 5-tuple of the header of the packet and the like. On the other hand, the security apparatus 20b executes the normal analysis processing on a packet by using higher layer information such as contents of the payload of the packet.

### Configuration of Assignment Apparatus

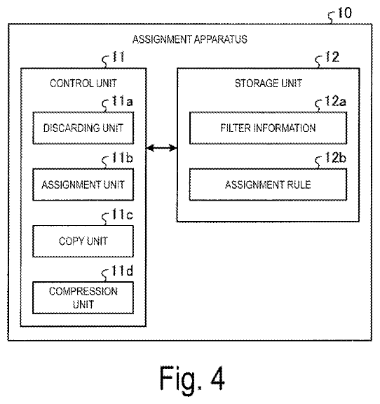

FIG. 4 is a schematic diagram illustrating an example of a schematic configuration of the assignment apparatus according to the present embodiment. The assignment apparatus 10 according to the present embodiment is implemented by a CPU, an NP, an FPGA, or the like, and executes a processing program stored in a memory to function as a control unit 11 as illustrated in FIG. 4. In addition, the assignment apparatus 10 includes a storage unit 12 that is implemented using a semiconductor memory device such as a RAM, a flash memory, or the like. In the present embodiment, the storage unit 12 stores filter information 12a and an assignment rule 12b.

The filter information 12a is information identifying an attack packet detected by the security apparatus (20a, 20b). The filter information 12a is notified from the controller 30 and stored in the storage unit 12, for example. Note that the filter information 12a may be stored in the storage unit 12 via, an input unit such as a keyboard or a mouse (not illustrated).

The assignment rule 12b is information designating a processing method for each predetermined flow in network traffic. For example, in the assignment rule 12b, a processing method for each protocol is designated. For example, with the assignment rule 12b. UDP and TCP flows used by DNS are designated to be subject to the normal analysis processing, and flows of other protocols are designated to be subject to the simple analysis processing.

Alternatively, with the assignment rule 12b, a processing method is designated for each destination IP address. For example, with the assignment rule 12b, each IP address of the destination user is designated to be subject to the normal analysis processing, subject to the resource friendly simple analysis processing, or the like, on the basis of the type of analysis service under contract with the user.

Alternatively, with the assignment rule 12b, a processing method is designated on the basis of the destination IP address and a time period required for executing detection processing or a time period required before starting the detection processing at the security apparatus. For example, with the assignment rule 12b, each IP address of the destination user is designated to be subject to the simple analysis processing, if due to the user contract, a time period required before starting the normal analysis processing for the target flow exceeds a predetermined time period so that the processing starts late. Alternatively, with the assignment rule 12b, each IP address of the destination user is designated to be subject to the simple analysis processing, if due to the user contract, a time period expected to be required for executing the normal analysis processing on the target flow exceeds a predetermined time period.

Note that the assignment rule 12b is stored in the storage unit 12 via an input unit such as a keyboard or a mouse (not illustrated), or via the controller 30 for example.

As illustrated in FIG. 4, the control unit 11 functions as a discarding unit 11a, an assignment unit 11b, a copy unit 11c, and a compression unit 11d. Note that each or a part of these function units may be implemented in different pieces of hardware. For example, the compression unit 11d may be incorporated at the security apparatus 20a that is implemented by a router or the like and executes the simple analysis processing.

The discarding unit 11a uses the filter information 12a to discard the attack packet in packets received from the network. Specifically, the discarding unit 11a identifies in the packets received from the network, the known attack packet stored in the filter information 12a, and discards this packet so as not to be used in the processing in the later stage.

The assignment unit 11b uses the assignment rule 12b to assign the packets received from the network to the copy unit 11c described later or to the other security apparatus 20b, for each predetermined flow. Specifically, the assignment unit 11b determines the packet to be subject to the simple analysis processing or subject to the normal analysis processing, or to be transferred to none of the security apparatuses, based on the processing method for each flow designated with the assignment rule 12b.

Furthermore, the assignment unit 11b transfers the packet determined to be subject to the simple analysis processing to the copy unit 11c described later, and transfers the packet determined to be subject to the normal analysis processing to the security apparatus 20b.

The copy unit 11c copies each of the packets received from the network. Specifically, the copy unit 11c copies each of the packets received from the network via the discarding unit 11a and the assignment unit 11b. The copy unit 11c transfers the copied packet to the compression unit 11d and transfers the original packet directly to the destination user. Furthermore, the copy unit 11c transfers the packet determined to be transferred to none of the security apparatuses, to the destination user without processing the packet.

The compression unit 11d compresses the payload of the copied packet and transfers a packet with the compressed payload to the security apparatus 20a. Specifically, the compression unit 11d compresses the payload portion of the copied packet, and transfers a packet with the compressed payload to the security apparatus 20a that executes the simple analysis processing. The compression unit 11d may delete the payload portion of the packet instead of compressing it. In such a case, the compression unit 11d transfers only the header of the copied packet to the security apparatus 20a. Furthermore, when compressing or deleting the payload of a packet, the compression unit 11d recalculates and changes a value such as a checksum related to the packet length.

### Configuration of Controller

The controller 30 is implemented by a CPU, an NP, an FPGA, and the like, and includes an acquisition unit 31a and a setting unit 31b. The acquisition unit 31a acquires information about the detected attack packet from the security apparatus (20a, 20b).

The setting unit 31b uses the information about the attack packet acquired from the security apparatus (20a, 20b) to cause the assignment apparatus 10 to store the filter information 12a. The setting unit 31b further causes the assignment apparatus 10 to store the assignment rule 12b.

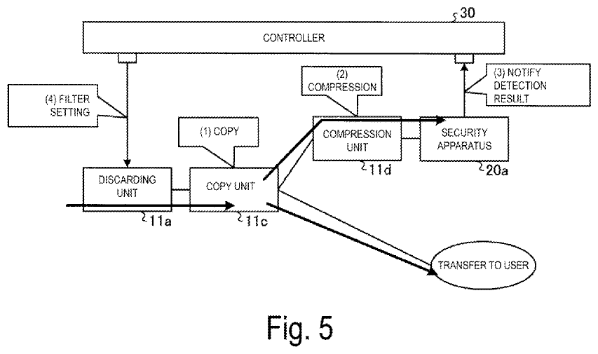

FIGS. 5 to 8 are explanatory diagrams illustrating processing executed by the assignment apparatus 10. First of all, as illustrated in FIG. 5, in the assignment apparatus 10, the copy unit 11c copies the received packet (step (1)) and transfers the copied packet to the compression unit 11d. The copy unit 11c also transfers the original packet to the destination user. The compression unit 11d compresses or deletes the payload portion of the copied packet (step (2)), and transfers a packet with the compressed payload to the security apparatus 20a that executes the simple analysis processing.

The security apparatus 20a executes the simple analysis processing using the packet with the payload compressed. Upon detecting an attack packet as a result of executing the simple analysis processing, the security apparatus 20a notifies the controller 30 of the detection result (step (3)).

The controller 30 uses the detection result notified from the security apparatus 20a to set the information identifying the detected attack packet, in the filter information 12a of the assignment apparatus 10 (step (4)). As a result, the discarding unit 11a of the assignment apparatus 10 thereafter discards the known attack packet identified by the filter information 12a, in the packets received from the network, so that the attack packet will not be processed in the later stage.

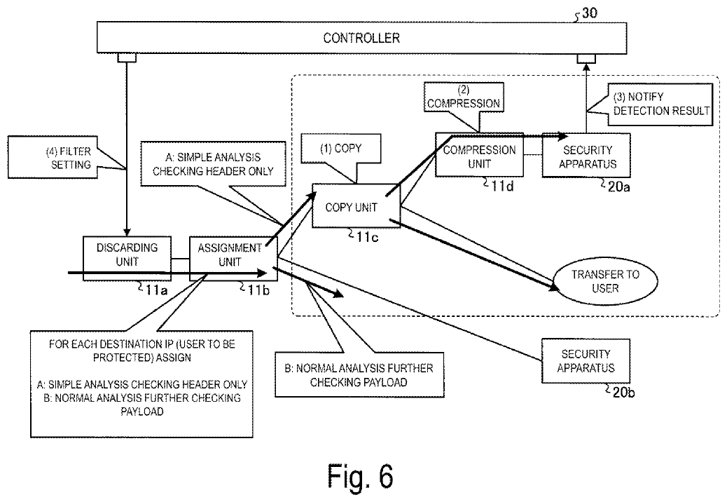

FIG. 6 differs from the processing illustrated in FIG. 5 in that the assignment unit 11b is added. The processing in the portions indicated by the surrounding dotted lines in FIG. 6 and FIG. 7 and FIG. 8 described later are the identical as the counterpart in the processing illustrated in FIG. 5.

The assignment unit 11b uses the assignment rule 12b designating the processing method for each predetermined flow of network traffic, to determine whether the received packet is to be subject to the simple analysis processing or to be subject to the normal analysis processing for each predetermined flow. Then, the assignment unit 11b transfers the packet determined to be subject to the simple analysis processing (A) to the copy unit 11c, and transfers the packet determined to be subject to the normal analysis processing (B) to the security apparatus 20b.

FIG. 6 illustrates an example of a case in which the processing method is designated for each destination IP address, with the assignment rule 12b. In this case, the assignment unit 11b assigns the simple analysis (A) or the normal analysis (B) to each destination IP address, that is, each user to be protected from the attack.

For example, the assignment unit 11b can determine each IP address of the destination user to be subject to the simple analysis processing or to be the normal analysis processing, on the basis of the type of the analysis service under contract with the user.

In the example illustrated in FIG. 6, with the assignment rule 12b, a processing method may be designated based on the destination IP address and a time period required for executing detection processing or a time period required before starting the detection processing at the security apparatus. For example, with the assignment rule 12b, each IP address of the destination user can be designated to be subject to the simple analysis processing, if due to the user contract, a time period required before starting the normal analysis processing for the target flow exceeds a predetermined time period so that the processing starts late.

Alternatively, with the assignment rule 12b, each IP address of the destination user can be designated to be subject to the simple analysis processing, if due to the user contract, a time period expected to be required for executing the normal analysis processing on the target flow exceeds a predetermined time period. The address can be designated to be subject to none of the normal analysis processing and the simple analysis processing.

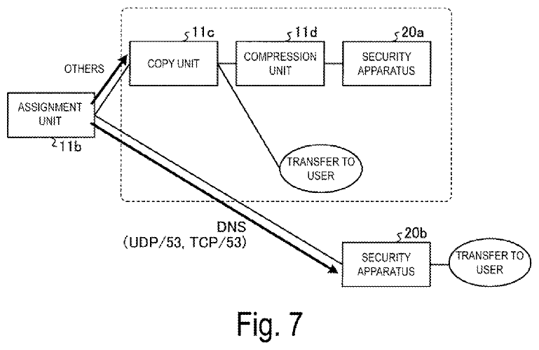

FIG. 7 differs from the processing illustrated in FIG. 6 in the content set in the assignment rule 12b. FIG. 7 illustrates an example of a case in which the processing method is designated for each protocol by using the assignment rule 12b. In such a case, the assignment unit 11b can designate UDP and TCP flows used by DNS to be subject to the normal analysis processing, and designate flows of other protocols to be subject to the simple analysis processing.

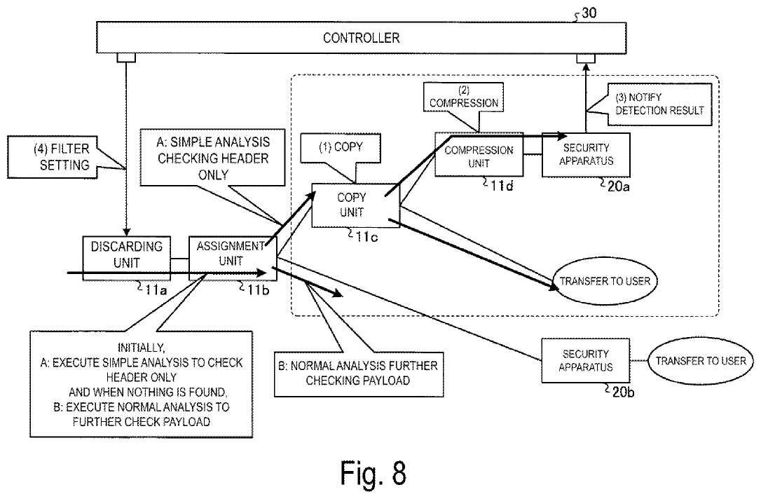

FIG. 8 also differs from the processing illustrated in FIG. 6 in the content set in the assignment rule 12b. FIG. 8 illustrates an example of a case Where the normal analysis processing (B) is designated to be executed after the simple analysis processing (A), in the assignment rule 12b. Thus, the assignment unit lib can cause the normal analysis processing (B) to be executed when no abnormality is found in the simple analysis processing (A). In this case, for example, the copy unit 11c transfers the copied packet to the security apparatus 20b, after the simple analysis processing (A), under the instruction from the assignment unit 11b.

### Assignment Processing

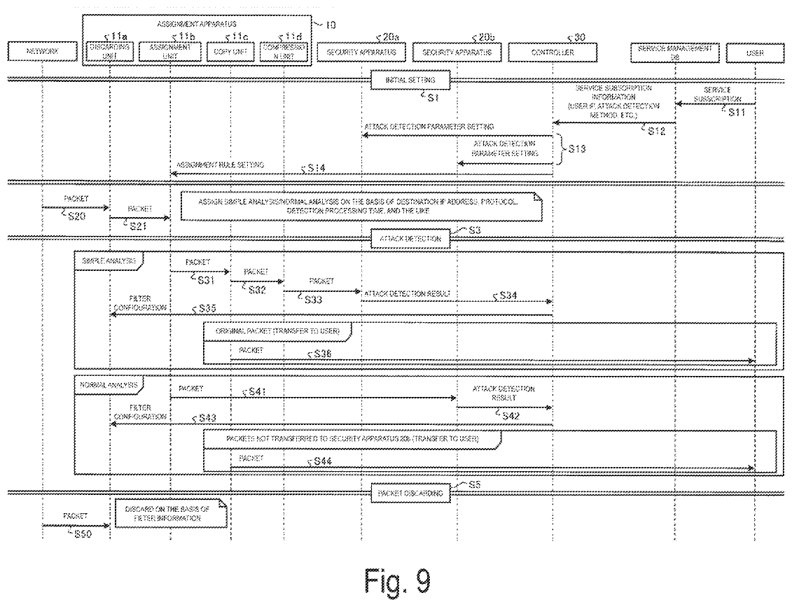

FIG. 9 is a sequence diagram illustrating an example of an assignment processing procedure. FIG. 9 illustrates an example of a case in which the simple analysis or the normal analysis is assigned to each destination user IP (see FIG. 6). The assignment processing illustrated in FIG. 9 includes initial setting processing (step S1), attack detection processing (step S3), and packet discarding processing (step S5).

First of all, in the initial setting process in step S1, when the user subscribes to an analysis service (step S11), the controller 30 is notified of the user's IP address and the type of the service such as an attack-detection method (step S12).

The controller 30 causes the security apparatus (20a, 20b) to set an attack-detection parameter on the basis of the type of the analysis service the user has subscribed to (step S13). Furthermore, the controller 30 causes the assignment apparatus 10 to set the assignment rule 12b to be subject to the simple analysis processing or the normal analysis processing, or to be subject to none of the normal analysis processing and the simple analysis processing, based on the type of the analysis service the user has subscribed to (step S14).

Prior to the attack detection processing in step S3, the discarding unit 11a in the assignment apparatus 10 discards the known attack packet in the packets received from the network (step S20). Furthermore, the assignment unit 11b assigns the simple analysis or the normal analysis, on the basis of the assignment rule 12b (step S21).

Note that the sequence from step S20 illustrated in FIG. 9 is not limited to a case where the assignment is implemented on the basis of the destination IP address using the assignment rule 12b. Thus, the processing from step S20 may be commonly executed in cases where, with the assignment rule 12b, the processing method is designated on the basis of the destination IP address and the required time period, and designated on the basis of the protocol (see FIG. 7).

When the packet is assigned to the simple analysis processing, the assignment unit 11b transfers the packet to the copy unit 11c (step S31). The copy unit 11c copies the received packet and transfers the copies packet to the compression unit 11d (step S32). The copy unit 11c transfers the original packet to the user without processing it (step S36).

The compression unit 11d compresses the payload of the packet and transfers a packet with the compressed payload to the security apparatus 20a (step S33).

On the other hand, when the packet is assigned to the normal analysis processing, the assignment unit 11b transfers the packet to the security apparatus 20b (step S41). When the packet is subject to none of the normal analysis processing and the simple analysis processing, the copy unit 11c transfers the packet to the user without processing it (step S44).

Upon detecting an attack packet, the security apparatus (20a, 20b) notifies the controller 30 of the detection result (step S34, S42). The controller 30 causes the assignment apparatus 10 to set the filter information 12a identifying the attack packet (steps S35, S43).

In the packet discarding processing in step S5, the discarding unit 11a of the assignment apparatus 10 uses the filter information 12a to identify, in the packets received from the network, as the known attack packet, the attack packet detected by the security apparatus (20a, 20b), and discards this packet (step S50).

As described above, in the assignment apparatus 10 according to the present embodiment, the copy unit 11c copies each of the packets received from the network. The compression unit 11d. compresses the payload of the copied packet and transfers a packet with the compressed payload to the security apparatus 20a.

Thus, the amount of data transferred to the security apparatus 20a that executes the simple analysis processing can be reduced. This increases packets that can be processed without increasing the resources of the security apparatus 20a, whereby a risk of resources of the security apparatus 20a running short can be reduced.

The storage unit 12 also stores the filter information 12a for identifying the attack packet detected by the security apparatus, and the discarding unit 11a uses the filter information to discard the attack packet in the packets received from the network. Thus, the known attack packet in the packets received from the network can be discarded.

The storage unit 12 stores the assignment rule 12b designating the processing method for each predetermined flow of the network traffic, and the assignment unit 11b uses the assignment rule 12b to assign the packets received from the network to the copy unit 11c or to the other security apparatus 20b, for each predetermined flow. This allows the received packets to be assigned to the simple analysis processing or to the normal analysis processing for each predetermined flow.

The storage unit 12 may store the assignment rule 12b designating the processing method for each protocol. In such a case, the assignment unit 11b uses the assignment rule 12b to assign the packets received from the network to the copy unit 11c or to the other security apparatus 20b, for each protocol. This enables UDP and TCP flows used by DNS to be designated to be subject to the normal analysis processing, and flows of other protocols to be designated as subject to the simple analysis processing, for example.

The storage unit 12 may store the assignment rule 12b designating the processing method for each destination IP address. In such a case, the assignment apparatus 10 uses the assignment rule 12b to assign the packets received from the network to the copy unit 11c or to the other security apparatus 20b, for each destination IP address. Thus, the assignment apparatus 10 can determine each IP address of the destination user to be subject to the simple analysis processing, to be the normal analysis processing, or the like on the basis of the type of the analysis service under contract with the user.

The storage unit 12 may store the assignment rule 12b designating a processing method on the basis of the destination IP address and a time period required for executing detection processing or a time period required before starting the detection processing at the security apparatus (20a, 20b). In this case, the assignment apparatus 10 uses the assignment rule 12b to assign the packets received from the network to the copy unit 11c or to the other security apparatus 20b, on the basis of the destination IP address and the time period required for the detection processing to be executed or the time period required before starting the detection processing at the security apparatus (20a, 20b).

Thus, for example, the assignment apparatus 10 can designate the packets received from the network to be subject to the simple analysis processing for each IP address of the destination user, if due to the user contract, a time period required before starting the normal analysis processing for the target flow exceeds a predetermined time period so that the processing starts late. Alternatively, the assignment apparatus 10 can designate each of the packets received from the network to be subject to the simple analysis processing for each IP address of the destination user, if due to the user contract, a time period expected to be required for executing the normal analysis processing on the target flow exceeds a predetermined time period.

At the security apparatus (20a, 20b) of the communication system 1 according to the present embodiment, the detection unit 21a detects an attack packet by analyzing the packets received from the assignment apparatus 10, and the notification unit 21b notifies the controller 30 of the information about the detected attack packet. In the controller 30, the acquisition unit 31a acquires the information about the detected attack packet from the security apparatus (20a, 20b), and the setting unit 31b uses the acquired information about the attack packet to store the filter information 12a in the assignment apparatus 10. This enables the attack packet to be easily and efficiently analyzed and discarded.

### Program

A program in which the processing executed by the assignment apparatus 10 according to the embodiment described above is described in a computer-executable language can be created as well. As one embodiment, the assignment apparatus 10 can be implemented by installing an assignment program for executing the assignment processing described above in a desired computer as packaged software or on-line software. For example, by causing an information processing apparatus to execute the assignment program described above, the information processing apparatus can be configured to function as the assignment apparatus 10. The information processing apparatus described here includes a desktop or laptop personal computer. In addition, a mobile communication terminal such as a smart phone or a mobile phone, and a slate terminal such as a Personal Digital Assistant (PDA) are included in the category of the information processing apparatus. Furthermore, the function of the assignment apparatus 10 may be implemented on the cloud server.

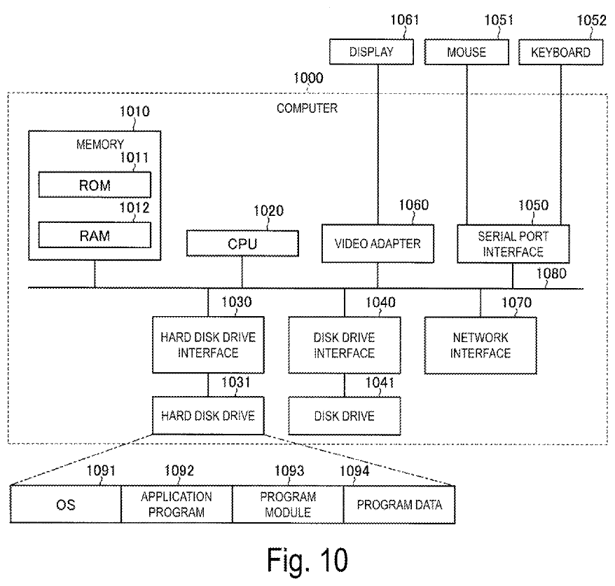

FIG. 10 is a diagram illustrating one example of a computer executing an assignment program. A computer 1000 has, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes Read Only Memory (ROM) 1011 and a RAM 1012. The ROM 1011 stores a boot program, such as Basic Input Output System (BIOS), for example. The hard disk drive interface 1030 is connected to the hard disk drive 1031. The disk drive interface 1040 is connected to a disk drive 1041. A detachable storage medium such as a magnetic disk or an optical disc, for example, is inserted into the disk drive 1041. A mouse 1051 and a keyboard 1052, for example, are connected to the serial port interface 1050. A display 1061. for example, is connected to the video adapter 1060.

Here, the hard disk drive 1031 stores, for example, an OS 1091, an application program 1092, a program module 1093, and program data 1094. The respective information described in the aforementioned embodiments are stored in, for example, the hard disk drive 1031 and the memory 1010.

In addition, the assignment program, for example, is stored in a hard disk drive 1031 as a program module 1093 in which commands to he executed by the computer 1000 are described. More specifically, the program module 1093 in which each processing executed by the assignment apparatus 10 described in the embodiment is described is stored in the hard disk drive 1031.

Data used in information processing according to the assignment program is stored, for example, in the hard disk drive 1031 as program data 1094. Then, the CPU 1020 reads the program module 1093 and the program data 1094 stored in the hard disk drive 1031 as needed in the RAM 1012 and executes each of the aforementioned procedures.

The program module 1093 or the program data 1094 relating to the assignment program is not necessarily stored in the hard disk drive 1031 and, for example, may be stored in a detachable storage medium and be read by the CPU 1020 through the disk drive 1041 or the like. Alternatively, the program module 1093 or the program data 1094 related to the assignment program may be stored in another computer connected via a network such as a Local Area Network (LAN) or a Wide Area Network (WAN) and read by the CPU 1020 via the network interface 1070.

Although the embodiments to which the invention made by the present inventors is applied have been described above, the invention is not limited by the description and the drawings as a part of the disclosure of the present invention according to the embodiments. In other words, all of other embodiments, examples, operation technologies, and the like made by those skilled in the art based on the embodiments are within the scope of the invention.

### REFERENCE SIGNS LIST

1 Communication system

10 Assignment apparatus

11 Control unit

11a Discarding unit

11b Assignment unit

11c Copy unit

11d Compression unit

12 Storage unit

12a Filter information

12b Assignment rule

20a, 20b Security apparatus

21a Detection unit

21b Notification unit

30 Controller

31a Acquisition unit

31b Setting unit

1. An assignment apparatus configured to transfer packets received from a network to a user and to a security apparatus configured to detect an attack packet, the assignment apparatus comprising:
a copy unit, including one or more processors, configured to copy each of the packets received from the network; and
a compression unit, including one or more processors, configured to compress a payload of each of the packets copied, to transfer a packet with the compressed payload to the security apparatus.

2. The assignment apparatus according to claim 1 further comprising:
a storage unit configured to store filter information identifying the attack packet detected by the security apparatus; and
a discarding unit, including one or more processors, configured to discard the attack packet in the packets received from the network by using the filter information.

3. The assignment apparatus according to claim 1 further comprising:
a storage unit configured to store an assignment rule designating a processing method for each predetermined flow in traffic of the network; and
an assignment unit, including one or more processors, configured to assign each of the packets received from the network to the copy unit or to another security apparatus for each of the predetermined flows, by using the assignment rule.

4. The assignment apparatus according to claim 3, wherein
the storage unit stores the assignment rule designating a processing method for each protocol, and
the assignment unit assigns each of the packets received from the network to the copy unit or to another security apparatus for each of the protocols, by using the assignment rule.

5. The assignment apparatus according to claim 3, wherein
the storage unit stores the assignment rule designating a processing method for each destination IP address, and
the assignment unit assigns each of the packets received from the network to the copy unit or to another security apparatus for each of the destination IP addresses, by using the assignment rule.

6. The assignment apparatus according to claim 3, wherein
the storage unit stores the assignment rule designating a processing method corresponding to a destination IP address and a time period required for executing detection processing or a time period required before starting the detection processing at the security apparatus, and
the assignment unit assigns each of the packets received from the network to the copy unit or another security apparatus, based on the destination IP address and the time period required for executing the detection processing or the time period required before starting the detection processing at the security apparatus, by using the assignment rule.

7. A communication system comprising:
a security apparatus configured to detect an attack packet;
an assignment apparatus configured to transfer packets received from a network to a user and to the security apparatus; and
a controller, wherein
the assignment apparatus includes
a storage unit configured to store filter information identifying the attack packet detected by the security apparatus,
a discarding unit, including one or more processors, configured to discard the attack packet by using the filter information,
a copy unit, including one or more processors, configured to copy the packets received from the network, and
a compression unit, including one or more processors, configured to compress a payload of each of the packets copied to transfer a packet with the compressed payload to the security apparatus,
the security apparatus includes
a detection unit, including one or more processors, configured to detect the attack packet through analysis on the packets received from the assignment apparatus, and
a notification unit, including one or more processors, configured to notify the controller of information about the attack packet detected, and
the controller includes
an acquisition unit, including one or more processors, configured to acquire the information about the attack packet detected from the security apparatus, and
a setting unit, including one or more processors, configured to cause the assignment apparatus to store the filter information, by using the information about the attack packet acquired form the security apparatus.

8. An assignment method performed in an assignment apparatus configured to transfer packets received from a network to a user and to a security apparatus configured to detect an attack packet, the method comprising:
copying each of the packets received from the network; and
compressing a payload of each of the packets copied to transferring a packet with the compressed payload to the security apparatus.

9. The assignment method according to claim 8, further comprising:
storing filter information identifying the attack packet detected by the security apparatus; and
discarding the attack packet in the packets received from the network by using the filter information.

10. The assignment method according to claim 8, further comprising:
storing an assignment rule designating a processing method for each predetermined flow in traffic of the network; and
assigning each of the packets received from the network to the copy unit or to another security apparatus for each of the predetermined flows, by using the assignment rule.

11. The assignment method according to claim 10, wherein:
the assignment rule designates a processing method for each protocol; and
the method further includes assigning each of the packets received from the network to the copy unit or to another security apparatus for each of the protocols, by using the assignment rule.

12. The assignment apparatus according to claim 10, wherein:
the assignment rule designates a processing method for each destination IP address, and
the method further includes assigning each of the packets received from the network to the copy unit or to another security apparatus for each of the destination IP addresses, by using the assignment rule.

13. The assignment apparatus according to claim 3, wherein:
the assignment rule designates a processing method corresponding to a destination IP address and a time period required for executing detection processing or a time period required before starting the detection processing at the security apparatus, and
the method further includes assigning each of the packets received from the network to the copy unit or another security apparatus, based on the destination IP address and the time period required for executing the detection processing or the time period required before starting the detection processing at the security apparatus, by using the assignment rule.
